(19) United States
(12) Patent Application Publication
(10) Pub. No.: US 2026/0155115 A1
(43) Pub. Date: Jun. 4, 2026

(54) DISPLAY DEVICE AND METHOD FOR CONTROLLING THEREOF

(71) Applicant: SAMSUNG ELECTRONICS CO., LTD., Suwon-si (KR)

(72) Inventors: Beomgeun CHU, Suwon-si (KR); Hyuntaek NA, Suwon-si (KR); Hoseong SEO, Suwon-si (KR)

(73) Assignee: SAMSUNG ELECTRONICS CO., LTD., Suwon-si (KR)

(21) Appl. No.: 19/322,179

(22) Filed: Sep. 8, 2025

Related U.S. Application Data
(63) Continuation of application No. PCT/KR2025/012572, filed on Aug. 19, 2025.

(30) Foreign Application Priority Data
Nov. 29, 2024 (KR) 10-2024-0175290

(51) Int. Cl. G09G 5/10; G06F 3/01

(52) U.S. Cl. CPC G09G 5/10; G06F 3/013; G09G 2320/0626; G09G 2320/0686; G09G 2354/00

(57) ABSTRACT

A display device may include: a sensor, a display screen, memory configured to store instructions, and at least one processor configured to, individually and/or collectively, execute the stored instructions to: based on information obtained by the sensor, track a gaze of a user to obtain a movement path of viewpoint coordinates corresponding to a movement path of the gaze on the display screen, determine a predicted viewpoint coordinate to which the gaze of the user is predicted to move on the display screen based on the obtained movement path of the viewpoint coordinates, control a first luminance value for a first display area of the display screen that includes the predicted viewpoint coordinate, and control a second luminance value for a second display area of the display screen, the second luminance value different from the first luminance value, and the second display area excluding the first display area.

### CROSS-REFERENCE TO RELATED APPLICATIONS

This application is a by-pass continuation application of International Application No. PCT/KR2025/012572, filed on Aug. 19, 2025, which is based on and claims priority to Korean Patent Application No. 10-2024-0175290, filed on Nov. 29, 2024, in the Korean Intellectual Property Office, the disclosures of which are incorporated by reference herein in their entireties.

### TECHNICAL FIELD

The disclosure relates to a display device for controlling the brightness of a display and a method for controlling the same.

### BACKGROUND ART

A display device is a type of device that converts obtained or stored electrical information into visual information for presentation to a user, and is used in various fields such as homes, schools, or workplaces.

The display device may include various types of audio/video systems, such as a personal digital assistant (PDA), a portable terminal device like a cellular phone, a monitor device connected to an electronic device like a personal computer or a server computer, a portable computer device, a navigation terminal device, a general television device, an Internet protocol television (IPTV) device, a smartphone, a tablet PC, and various display devices used in industrial sites for playing images such as advertisements or movies, a stereoscopic display device for playing 3D contents, or other types of audio/video systems.

As the size and/or resolution of the panel of the display device increases, various technologies are being researched to reduce power consumption.

The above-described information may be provided as related art for the purpose of helping understanding of the disclosure. The foregoing cannot be claimed as, or used to determine, the prior art related to the disclosure.

### DISCLOSURE OF INVENTION

### Solution to Problems

The disclosure provides a display device for controlling the brightness of a display and a method for controlling the same. The term ‘brightness’ as used herein may be interchangeably used with the term ‘luminance’ unless stated otherwise.

In accordance with an embodiment of the present disclosure, a display device may include: a sensor, a display screen, memory configured to store instructions, and at least one processor configured to, individually and/or collectively, execute the stored instructions to: based on information obtained by the sensor, track a gaze of a user to obtain a movement path of viewpoint coordinates corresponding to a movement path of the tracked gaze on the display screen, determine a predicted viewpoint coordinate to which the gaze of the user is predicted to move on the display screen based on the obtained movement path of the viewpoint coordinates, and control a first luminance value for a first display area of the display screen that includes the predicted viewpoint coordinate, and control a second luminance value for a second display area of the display screen, the second luminance value being different from the first luminance value, and the second display area excluding the first display area.

The instructions may be configured to control the second luminance value to decrease based on a separation distance from the predicted viewpoint coordinate.

The instructions may be configured to control the second luminance value such that a brightness of the second display area decreases over a time period.

The instructions may be configured to control the first luminance value such that a brightness of the first display area immediately increases.

The instructions may be configured to: identify a dimming block of the display screen that includes the predicted viewpoint coordinate among a plurality of dimming blocks that divide the display screen, and independently control a luminance value of the identified dimming block and luminance values of dimming blocks among the plurality of dimming blocks that surround the identified dimming block.

A first dimming block among the dimming blocks that surround the identified dimming block may have a first separation distance from the predicted viewpoint coordinate, a second dimming block among the dimming blocks that surround the identified dimming block may have a second separation distance from the predicted viewpoint coordinate that is larger than the first separation distance, and the instructions may be further configured to decrease a luminance value of the second dimming block by a larger amount than a luminance value of the first dimming block.

The instructions may be configured to: based on a viewpoint coordinate corresponding to the gaze of the user not matching the predicted viewpoint coordinate, control a third luminance value for a third display area of the display screen that includes the viewpoint coordinate corresponding to the gaze of the user, and control a fourth luminance value for a fourth display area of the display screen, the fourth display area excluding the third display area.

The instructions may be configured to: based on the determination that the gaze of the user is not detected for a time period, control a luminance value for an entirety of the display screen to have a brightness equal to or less than a threshold level.

The instructions may be configured to: based on the determination that a plurality of users are gazing at the display screen, control a luminance value for an entirety of the display screen to have a reference brightness.

The instructions may be configured to: based on the information obtained by the sensor, obtain a separation distance between the display screen and the user, and control the second luminance value based on the obtained separation distance between the display screen and the user.

In accordance with an embodiment of the present disclosure, a method for controlling a display device including a sensor, a display screen, memory configured to store instructions, and at least one processor configured to, individually and/or collectively, execute the stored instructions to perform the method may include: based on information obtained by the sensor, tracking a gaze of a user to obtain a movement path of viewpoint coordinates corresponding to a movement path of the tracked gaze on the display screen, determining a predicted viewpoint coordinate to which the gaze of the user is predicted to move on the display screen based on the obtained movement path of the viewpoint coordinates, and controlling a first luminance value for a first display area of the display screen that includes the predicted viewpoint coordinate, and controlling a second luminance value for a second display area of the display screen, the second luminance value being different from the first luminance value, and the second display area excluding the first display area.

The method may further include controlling the second luminance value to decrease based on a separation distance from the predicted viewpoint coordinate.

The method may further include controlling the second luminance value such that a brightness of the second display area decreases over a time period.

The method may further include controlling the first luminance value such that a brightness of the first display area immediately increases.

The method may further include: identifying a dimming block of the display screen that includes the predicted viewpoint coordinate among a plurality of dimming blocks that divide the display screen, and independently controlling a luminance value of the identified dimming block and luminance values of dimming blocks among the plurality of dimming blocks that surround the identified dimming block.

A first dimming block among the dimming blocks that surround the identified dimming block may have a first separation distance from the predicted viewpoint coordinate, a second dimming block among the dimming blocks that surround the identified dimming block may have a second separation distance from the predicted viewpoint coordinate that is larger than the first separation distance, and the method may further include decreasing a luminance value of the second dimming block by a larger amount than a luminance value of the first dimming block.

The method may further include: based on a viewpoint coordinate corresponding to the gaze of the user according to the information obtained by the sensor not matching the predicted viewpoint coordinate, controlling a third luminance value for a third display area of the display screen that includes the viewpoint coordinate corresponding to the gaze of the user, and controlling a fourth luminance value for a fourth display area of the display screen, the fourth display area excluding the third display area.

The method may further include: based on the determination that the gaze of the user may be not detected for a time period, controlling a luminance value for an entirety of the display screen to have a brightness equal to or less than a threshold level.

The method may further include: based on the determination that a plurality of users are gazing at the display screen, controlling a luminance value for an entirety of the display screen to have a reference brightness.

The method may further include: based on the information obtained by the sensor, obtaining a separation distance between the display screen and the user; and controlling the second luminance value based on the obtained separation distance between the display screen and the user.

### BRIEF DESCRIPTION OF DRAWINGS

FIG. 1 is a block diagram illustrating an example display device capable of operations described in the disclosure;

FIG. 2 illustrates a structure related to a display panel of a display device according to an embodiment;

FIG. 3 illustrates a light source device included in a display device according to an embodiment;

FIG. 4 is a view illustrating a procedure of controlling luminance based on gaze of a user in a display device according to an embodiment;

FIG. 5 is a block diagram for implementing local dimming based on gaze of a user in a display device according to an embodiment;

FIG. 6 is a flowchart illustrating a procedure of controlling local dimming in a display device according to an embodiment;

FIGS. 7A and 7B are a flowchart illustrating a procedure of controlling local dimming in a display device according to an embodiment;

FIG. 8 illustrates an operation of controlling the brightness of a display when a user is not detected in a display device according to an embodiment;

FIG. 9 illustrates an operation of obtaining a setting luminance adjust ratio during local dimming based on gaze of a user;

FIG. 10 illustrates an operation of changing a luminance adjustment ratio in a display device according to an embodiment;

FIG. 11 illustrates an operation of updating a luminance adjustment ratio in response to gaze of a user in a display device according to an embodiment;

FIG. 12 illustrates the determination of a predicted viewpoint coordinate in a display device according to an embodiment; and

FIGS. 13A and 13B illustrate simulation results related to luminance control of a display according to an embodiment.

### MODE FOR THE INVENTION

The display device according to various embodiments of the disclosure may be one of various types of electronic devices. The display devices may include, for example, a portable communication device (e.g., a smartphone), a computer device, a portable multimedia device, a portable medical device, a camera, a wearable device, or a home appliance. The display devices according to an embodiment of the disclosure are not limited to the above-described devices.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

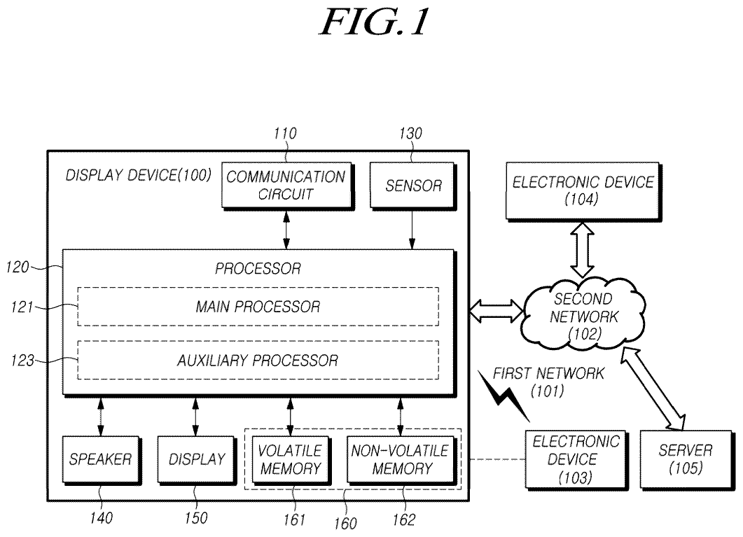

FIG. 1 is a block diagram illustrating an example display device 100 capable of operations described in the disclosure.

Referring to FIG. 1, a display device 100 may be one of various types of electronic devices, such as liquid crystal display (LCD) or mini light emitting diode (LED) televisions (TVs), monitors, tablets, or other similar devices (not shown). The components illustrated in FIG. 1, and their relationships and functions are merely examples and do not limit implementations described or claimed in the disclosure.

The display device 100 may communicate with an external electronic device 103 (e.g., a smartphone) via a first network 101 (e.g., a short-range wireless communication network) in a network environment. The display device 100 may communicate with at least one of an external electronic device 104 (e.g., a smartphone) or a server 105 (e.g., a smart home server) via a second network 102 (e.g., a long-range wireless communication network) in the network environment. The display device 100 may communicate with an external electronic device (e.g., a refrigerator, a washing machine, a cleaner, an air conditioner, a lighting, or the like) via the server 105. Each of the external electronic devices 103 or 104 may be the same as or different from the display device 100. All or some of the operations executed by the display device 100 may be executed by one or more of the external electronic devices 103, 104, or 105. For example, when the display device 100 should perform a function or service automatically or in response to a request from a user or another device, the display device 100 may request one or more external electronic devices to perform at least a part of the function or the service, instead of or in addition to executing the function or the service by itself. Upon receiving the request, the one or more external electronic devices may execute at least a part of the requested function or service, or an additional function or service related to the request, and transfer the result of the execution to the display device 100. The display device 100 may process the received result as it is or additionally, and may provide the same as at least a part of the response to the request. To that end, cloud computing, distributed computing, mobile edge computing (MEC), or client-server computing technology may be used. The display device 100 may provide an ultra-low latency service using, e.g., distributed computing or mobile edge computing. The external electronic device 104 may include an Internet of things (IoT) device. The server 105 may be an intelligent server using machine learning and/or a neural network. The external electronic device 104 or the server 105 may be included in the second network 102. The display device 100 may be applied to intelligent services (e.g., smart home, smart city, smart car, or healthcare) based on 5G communication technology and IoT-related technology. For example, the display device 100 may receive video signals and/or audio signals via a network (e.g., the first and/or second network 101, 102).

The display device 100 may include a communication circuitry 110, a processor 120, a sensor 130, a speaker 140, a display 150, and/or memory 160 (e.g., a volatile memory 161 and/or a non-volatile memory 162) as components. The above-described components may be connected mutually or communicate signals (e.g., commands or data) therebetween based on a predetermined communication scheme (e.g., a bus, general purpose input and output (GPIO), serial peripheral interface (SPI), or mobile industry processor interface (MIPI)). The above-described components are merely examples. For example, the display device 100 may include other components (e.g., a power management integrated circuit (PMIC), a connecting terminal, or an input/output interface). At least one of the components included in the display device 100 may be omitted, or one or more other components may be added. Some of the components included in the display device 100 may be integrated into one component.

The processor 120 may execute software (e.g., an application program, a driving program, and/or a system program) to control at least one other component (e.g., a hardware or software component) of the display device 100. To that end, the processor 120 may perform various data processing and/or operations. As at least part of the data processing and/or computation, the processor 120 may store a command or data received from another component (e.g., the communication circuitry 110 or the sensor 130) in the volatile memory 161. The processor 120 may process the command or data stored in the volatile memory 161, and may store resulting data in the non-volatile memory 162.

The processor 120 may be implemented as one or more integrated circuit (IC) chips and may perform various data processing. For example, the processor 120 (or an application processor (AP)) may be implemented as a system on chip (SoC) (e.g., one chip or chipset). The processor 120 may execute, e.g., software to control at least one other component (e.g., a hardware or software component) of the display device 100 connected to the processor 120, and may perform various data processing or computation. According to an example, as at least part of the data processing or computation, the processor 120 may store a command or data received from another component (e.g., the communication circuitry 110 or the sensor 130) in volatile memory 161, process the command or the data stored in the volatile memory 161, and store resulting data in non-volatile memory 162. According to an example, the processor 120 may include a main processor 121 (e.g., a central processing unit (CPU) or AP), or an auxiliary processor 123 (e.g., a graphics processing unit (GPU), a neural processing unit (NPU), an image signal processor (ISP), or a communication processor (CP)) that is operable independently from, or in conjunction with, the main processor. For example, when the display device 100 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the communication circuitry 110, the sensor 130, the speaker 140, or the display 150) among the components of the display device 100, instead of the main processor 121 while the main processor 121 is in an inactive (e.g., sleep) state, or together with the main processor 121 while the main processor 121 is in an active state (e.g., executing an application). According to an example, the auxiliary processor 123 (e.g., an image signal processor or a communication processor) may be implemented as part of another component (e.g., the communication circuitry 110) functionally related to the auxiliary processor 123. According to an example, the auxiliary processor 123 (e.g., the neural processing unit) may include a hardware structure specified for artificial intelligence model processing. The artificial intelligence model may be generated via machine learning. Such learning may be performed, e.g., by the display device 100 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The communication circuitry 110 may support establishing a direct (e.g., wired) communication channel or a wireless communication channel between the display device 100 and the external electronic device (e.g., the electronic device 103 or 104, or the server 105) and performing communication via the established communication channel. The communication circuitry 110 may support direct (e.g., wired) communication or wireless communication. The communication circuitry 110 may include a wireless communication module (e.g., a cellular communication module, a short-range wireless communication module, or a global navigation satellite system (GNSS) communication module) or a wired communication module (e.g., a local area network (LAN) communication module or a power line communication module). A corresponding one of these communication modules may communicate with the external electronic device 104 via a first network 101 (e.g., a short-range communication network, such as Bluetooth™, wireless-fidelity (Wi-Fi) direct, or infrared data association (IrDA)) or a second network 102 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. For example, the display device 100 may receive video signals and/or audio signals through the communication circuitry 110.

The sensor 130 may detect an operational state (e.g., power or temperature) of the display device 100 or an environmental state (e.g., a state of a user) outside the display device 100, and generate an electrical signal or data value corresponding to the detected state. The sensor 130 may include, e.g., a gesture sensor, a gyro sensor, an atmospheric pressure sensor, a magnetic sensor, an acceleration sensor, a grip sensor, a proximity sensor, a color sensor, an infrared (IR) sensor, a bio sensor, a temperature sensor, a humidity sensor, or an illuminance sensor. According to an example, the sensor 130 may include a camera. The camera may include a plurality of cameras (stereo cameras), RGB-D cameras, or time-of-flight (ToF) cameras. However, the sensor 130 is not limited thereto and may include various sensors that may obtain frames and depth information.

The speaker 140 may output sound signals (or audio signals) to the outside of the display device 100. The speaker 140 may be used for general purposes such as multimedia playback or recording playback. The volume of the speaker 140 may increase or decrease in response to control of the processor 120.

The display 150 may visually output information to the outside (e.g., the user) of the display device 100. The display 150 may include a display panel substantially displaying screens. The display 150 may include, e.g., a display, a hologram device, or a projector and a control circuit to control a corresponding device. The display 150 may include a touch sensor configured to detect a touch, or a pressure sensor configured to measure the intensity of a force generated by the touch.

The memory 160 may store various data used by at least one component (e.g., the processor 120 or the sensor 130) of the display device 100. The various data may include, for example, software (e.g., the program) and/or input data or output data for a command related thereto. The memory 160 may include the volatile memory 161 or the non-volatile memory 162. The memory 160 may store programs and data for processing video signals and/or audio signals. The memory 160 may temporarily store data that is generated while processing video signals and/or audio signals.

The display device 100 may further include an interface or connecting terminal. The interface may support one or more specified protocols to be used for the display device 100 to be coupled with the external electronic device (e.g., the electronic device 103) directly (e.g., wiredly) or wirelessly. The interface may include, e.g., a high definition multimedia interface (HDMI), a universal serial bus (USB) interface, a secure digital (SD) card interface, or an audio interface. A connecting terminal may include a connector via which the display device 100 may be physically connected with the external electronic device (e.g., the electronic device 103). The connecting terminal may include, for example, a HDMI connector, a USB connector, a SD card connector, or an audio connector (e.g., a headphone connector). For example, the display device 100 may receive video signals and/or audio signals through an interface or connecting terminal.

According to an example, a method according to various examples of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various examples, each component (e.g., a module or a program) of the above-described components may include a single entity or multiple entities. Some of the plurality of entities may be separately disposed in different components. According to various examples, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various examples, operations performed by the module, the program, or another component may be carried out sequentially, in parallel, repeatedly, or heuristically, or one or more of the operations may be executed in a different order or omitted, or one or more other operations may be added.

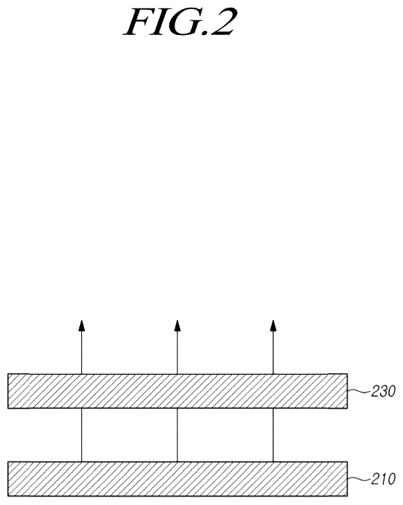

FIG. 2 illustrates a structure related to a display panel of a display device (e.g., the display device 100 of FIG. 1) according to an embodiment.

Referring to FIG. 2, the display panel included in the display device 100 is a component that substantially outputs a screen using various materials such as a liquid crystal display (LCD), a light emitting diode (LED), or an organic light emitting diode (OLED). For example, when the display panel is implemented as an LCD panel, the display device 100 may include a light source device 210 and a liquid crystal panel 230 that blocks or transmits light emitted from the light source device 210.

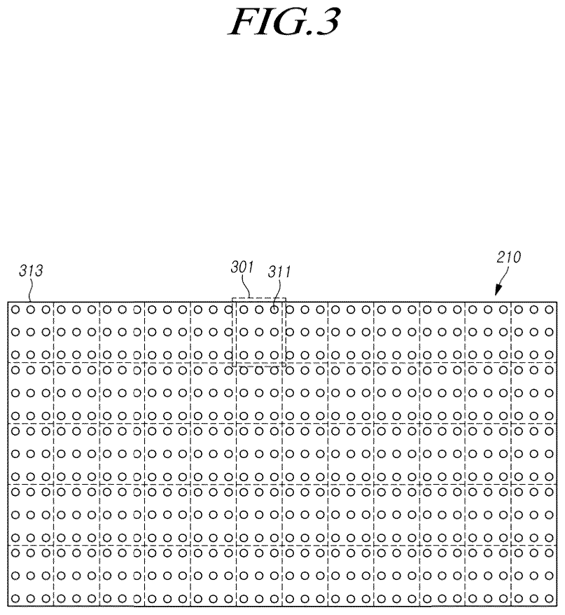

According to an embodiment, the light source device 210 may include a plurality of light sources and may output surface light by diffusing light emitted from the plurality of light sources. For example, the light source device 210 is as illustrated in FIG. 3.

According to an embodiment, the liquid crystal panel 230 may include a plurality of pixels, and control the plurality of pixels so that each of the plurality of pixels transmits or blocks light. An image may be formed by light passing through each of the plurality of pixels.

According to an embodiment, the liquid crystal panel 230 is provided at the front, which is the direction in which light is emitted from the light source device 210, and blocks or transmits light emitted from the light source device 210 to form an image.

According to an embodiment, the front of the liquid crystal panel 230 may display a still image or a moving image. The liquid crystal panel 230 may have a plurality of pixels P. The plurality of pixels P may independently block or transmit the light of the light source device 210. The light passing through the plurality of pixels P may provide an image for a viewer to watch.

According to an embodiment, the plurality of pixels P may emit light of various brightness levels and various colors. To emit light of various colors, each of the plurality of pixels P may include subpixels P_{R}, P_{G}, and P_{B}. The subpixels P_{R}, P_{G}, and P_{B} may include a red subpixel P_{R} capable of emitting red light. The subpixels P_{R}, P_{G}, and P_{B} may include a green subpixel P_{G} capable of emitting green light. The subpixels P_{R}, P_{G}, and P_{B} may include a blue subpixel P_{B} capable of emitting blue light. For example, red light may represent light with a wavelength of about 700 nm (nanometer, one billionth of a meter) to 800 nm. Green light may represent light with a wavelength of about 500 nm to 600 nm. Blue light may represent light with a wavelength of about 400 nm to 500 nm.

According to an embodiment, in the plurality of pixels P, light of various brightness levels and colors may be output by a combination of or a single light of the red light of the red subpixel P_{R}, the green light of the green subpixel P_{G}, and/or the blue light of the blue subpixel P_{B}.

FIG. 3 illustrates a light source device included in a display device (e.g., the display device 100 of FIG. 1) according to an embodiment.

Referring to FIG. 3, the light source device (e.g., the light source device 210 of FIG. 2) may include a plurality of dimming blocks 301 arranged in a matrix form. The plurality of dimming blocks 301 each may include, e.g., a substrate 313 that supports/fixes at least one and/or a plurality of light source 311.

The plurality of dimming blocks 301 may be configured in the form of an M*N matrix (where M and N are natural numbers). The M*N matrix means a matrix with M rows and N columns. For example, the plurality of dimming blocks 301 may be configured with 5 rows and 12 columns. In this case, the light source device 210 may include a total of 60 dimming blocks 301. However, the number of dimming blocks 301 is not limited to a specific number and may be changed as needed.

According to an embodiment, the light source 311 may use an element capable of emitting monochromatic light (light of a specific wavelength, e.g., blue light) or white light (e.g., mixed light of red light, green light, and blue light). The light source 311 may emit monochromatic light or white light in various directions. For example, an element that may be used as the light source 311 may include a light emitting diode (LED). The light emitting diode may be implemented in various sizes. The light emitting diode may include, e.g., a mini LED and/or a micro LED.

According to an embodiment, the substrate 313 may fix the plurality of light sources 311 so that the position of the light source 311 does not change. The substrate 313 may supply power to the light source 311 for emitting light. According to an embodiment, the substrate 313 may include a synthetic resin, reinforced glass, and/or a printed circuit board (PCB) in which a conductive power supply line for supplying power to a plurality of light sources 311 is formed and the light sources 311 are fixed.

According to an embodiment, the light sources 311 belonging to the dimming block 301 may emit light of the same intensity. According to an embodiment, light sources belonging to different dimming blocks may emit light of different intensities.

According to an embodiment, the display device 100 may divide the light source device 210 into a plurality of blocks and independently adjust current (or voltage or both current and voltage) for each block according to an input image. For example, the display device 100 may use local dimming technology to control brightness in one or more dimming block units.

The display device 100 may receive a content including a video signal and an audio signal from one or more content sources and output video (or image) and audio (or sound) corresponding to the video signal and audio signal. The display device 100 adopts local dimming technology to enhance power consumption while enhancing the contrast ratio of the video. Local dimming technology is, for example, technology for individually controlling the brightness of light to be emitted for one or more dimming blocks based on contents. The display device 100 adopting local dimming technology may control each dimming block to emit different levels of light. For example, the display device 100 may decrease the brightness of a light source 311 corresponding to a dark portion of an image in the light source device 210 and increase the brightness of a light source 311 corresponding to a bright portion of the image.

In an example, when applying dimming to uniformly adjust brightness for the entire screen of the display device 100, it may be inefficient in terms of energy consumption. For example, the display device 100 may output a bright screen even when the user is not viewing the screen. Further, even when the user is viewing the screen, the display device 100 may control brightness of areas outside gaze of the user in the same manner as areas within the gaze of the user. As such, in order to reduce unnecessary power consumption in the display, the display device 100 needs to apply local dimming technology to control brightness for each display area considering the gaze of the user. In an example, the display device 100 may reduce power consumed by the display by reducing the brightness of areas not in the gaze of the user.

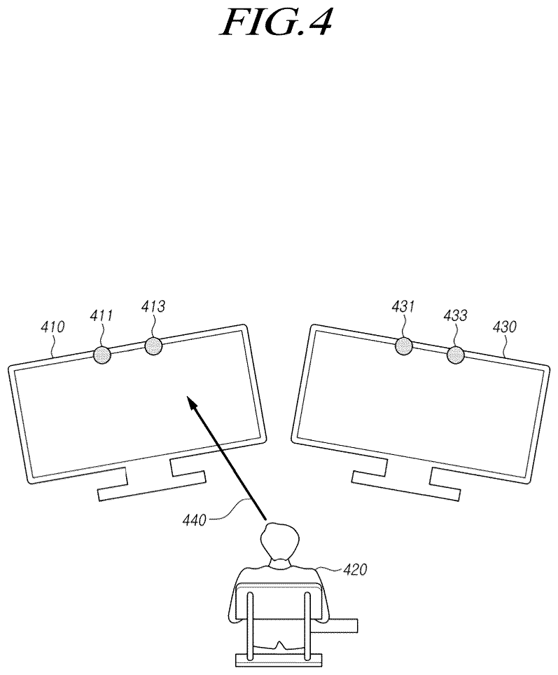

FIG. 4 is a view illustrating a procedure for controlling luminance based on gaze of a user in a display device (e.g., the display device 100 of FIG. 1) according to an embodiment. For example, the display device 100 may perform a procedure for reducing the brightness of areas outside the gaze of the user.

In FIG. 4, two monitors 410, 430 are assumed for convenience of explanation, but implementations according to the description below may be equally applied to one monitor or three or more monitors.

Referring to FIG. 4, the display device 100 may output a screen to two or more monitors 410, 430 (hereinafter referred to as a ‘first monitor 410’ and a ‘second monitor 430’). The first monitor 410 and/or the second monitor 430 may include one or more cameras 411, 413 or 431, 433 on the front surface facing the user 420. The camera 411, 413 or 431, 433 may capture the face of the user 420 facing the front surface of the monitors 410, 430. The display device 100 may identify the presence of the user 420 based on an image captured by the camera 411, 413 or 431, 433. In response to identifying the presence of the user, the display device 100 may perform local dimming based on the coordinates toward which the user's gaze 420 is directed on the monitors 410, 430. According to an embodiment, the display device 100 may perform local dimming to divide the entire display screen of at least one monitor 410, 430 into a plurality of areas and control luminance (or brightness) (hereinafter referred to as ‘luminance’) for each divided area. Here, the at least one monitor 410, 430 may indicate either the first monitor 410 or the second monitor 430, or both the first and second monitors 410, 430. For local dimming, the display device 100 may obtain information regarding the user's gaze 440 based on the user image (e.g., the user's face image) captured by the camera 411, 413 or 431, 433. For example, the information regarding the user's gaze 440 may be the direction information in which the user 420 is looking. The direction information may be, e.g., information on a direction vector corresponding to the direction in which the user 420 is looking. The display device 100 may analyze the obtained information regarding the user's gaze 440 to predict or obtain the coordinates (hereinafter referred to as 'reference coordinates') reached (or directed) by the user's gaze 440 on the monitor 410 or 430. For example, the display device 100 may determine a first area on the entire display screen including the obtained reference coordinates. The display device 100 may apply local dimming to differently adjust the brightness of the first area and a second area. The second area may correspond to an area excluding the first area from the entire display screen. According to an embodiment, the second area may be divided into a plurality of divided areas. For example, the display device 100 may apply different luminance in the second area according to the distance from the first area. For example, when the second area is divided into a first divided area at a relatively close distance and a second divided area at a relatively far distance based on the distance from the first area, the display device 100 may reduce the luminance of the second divided area relatively more than that of the first divided area. For example, the screen output through the display may include objects or areas with high luminance, such as the sun or lighting, and objects or areas with low luminance, such as shadows. The display device 100 may adjust the luminance of each area included in the entire display screen, considering the unique reference luminance to be output for such objects or areas and the gaze of the user.

The first image of the user 420 captured by the first camera 411, 413 provided on the first monitor 410 and the second image of the user 420 captured by the second camera 431, 433 provided on the second monitor 430 may differ. The display device 100 may identify the presence of the user 420 based on the first image captured by the first camera 411, 413 and/or the second image captured by the second camera 431, 433.

In an example, it may be assumed that the first image captured by the first camera 411, 413 includes the user 420, and the second image captured by the second camera 431, 433 does not include the user 420. In this case, the display device 100 may analyze the first image captured by the first camera 411, 413 to recognize that the user 420 is present and analyze the second image captured by the second camera 431, 433 to recognize that the user 420 is not present. According to an embodiment, the display device 100 may adjust the luminance of the entire display screen of the second monitor 430 to a threshold level or less in response to identifying the absence of the user 420 based on the analysis result of the second image captured by the second camera 431, 433. For example, to adjust the luminance of the entire display screen of the second monitor 430 to the threshold level or less, the display device 100 may uniformly decrease the luminance of the entire display screen. For example, the display device 100 may decrease the luminance of the entire display screen at the same rate.

According to an embodiment, the display device 100 may identify the presence of the user 420 based on images (e.g., the first image and/or the second image) captured periodically or aperiodically by the first camera 411, 413 and/or the second camera 431, 433. According to an embodiment, the display device 100 may count the number of images in which the presence of the user 420 is not identified among the images captured periodically and/or aperiodically. According to an embodiment, the display device 100 may determine that the user 420 is absent when the number of counted images exceeds a threshold number.

In an example, when the user 420 is gazing at the first monitor 410 out of the two monitors 410, 430, the display device 100 may not obtain the reference coordinates toward which the gaze of the user 420 is directed on the first and/or second monitor 410, 430, even when the presence of the user 420 may be identified based on the images captured by the first camera 411, 413 and/or the second camera 431, 433. For example, the display device 100 may adjust the luminance of the entire display screen of the second monitor 430 to the threshold level or less in response to not obtaining the reference coordinates on the display screen of the second monitor 430 corresponding to the gaze of the user 420. In this case, similar to counting the number of images in which the presence of the user 420 is not identified, the display device 100 may count the number of images in which the reference coordinates toward which the gaze of the user 420 is directed are not obtained, and when the counted number exceeds a threshold number, adjust the luminance of the entire display screen of the second monitor 430 to the threshold level or less.

According to an embodiment, the display device 100 may decrease the luminance of the display area toward which gaze of the user is not directed. The display device 100 may reduce power consumption without affecting the image quality perceived by the user. The luminance control method of the display device 100 may be applied to a 3D monitor, wide monitor, or multi-monitor (e.g., dual monitor) environment.

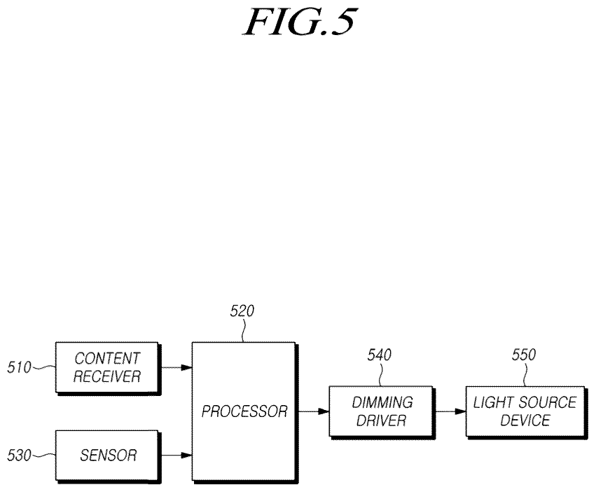

FIG. 5 is a block diagram for implementing local dimming based on gaze of a user (e.g., the user 420 of FIG. 4) in a display device (e.g., the display device 100 of FIG. 1) according to an embodiment.

Referring to FIG. 5, a display device 100 according to an example may include at least some of a content receiver 510, a sensor 530 (e.g., the sensor 130 of FIG. 1), a processor 520 (e.g., the processor 120 of FIG. 1), a dimming driver 540, a light source device 550 (e.g., the light source device 210 of FIG. 2), or a display panel (not illustrated). According to an embodiment, the sensor 530 may be included in the display device 100. According to an embodiment, the sensor 530 may be connected to the display device 100 via a predetermined interface port as an external device. According to an embodiment, light output from the light source device 550 may form an image on the display panel. According to an embodiment, the display panel may be provided as a separate component externally. For example, the display device 100 that emits a light signal via the light source device 550, e.g., an image projection device (e.g., a projector), may not be equipped with a display panel. In this case, the light signal emitted by the light source device 550 of the display device 100 may be displayed as an image on a projection plane such as a screen. In the following description, the display device 100 including a display panel is assumed for description, but the disclosure may also be applied to an image projection device such as a projector.

According to an embodiment, the content receiver 510 may receive contents including video signals and/or audio signals from one or more content sources (hereinafter referred to as ‘content source’). For example, the content receiver 510 may include a communication circuitry (e.g., the communication circuitry 110 of FIG. 1) or a network (e.g., the first and/or second network 101, 102 of FIG. 1). For example, the content receiver 510 may include an interface or connecting terminal for receiving contents including video signals and/or audio signals from the content source.

According to an embodiment, the sensor 530 may include an image sensor corresponding to a camera (e.g., the first camera 411, 413 or the second camera 431, 433 of FIG. 4). In the following description, the term ‘camera’ is used to collectively refer to a component that converts light into a digital image, such as an image sensor.

According to an embodiment, the sensor 530 may capture images. For example, the sensor 530 may be disposed on the front surface of the display device 100. For example, the sensor 530 provided in the display device 100 may capture the user in the field of view. For example, the sensor 530 may obtain a user image including the user.

According to an embodiment, the sensor 530 may transmit the captured image to the processor 520. For example, the sensor 530 may capture images periodically or aperiodically and transmit the captured images to the processor 520. For example, the sensor 530 may capture images in accordance with the frame rate (i.e., the rate at which the display device displays one screen data). Accordingly, the image captured by the sensor 530 may correspond to the frame displayed on the screen of the display device 100. For example, the frame rate refers to the number of times the display (e.g., the display 150 of FIG. 1) represents a frame on the screen per second, using Hz (Hertz) as a unit representing the number of repetitions per second. For example, a display with a frame rate of 60 Hz may mean that it displays 60 frames per second.

According to an embodiment, the sensor 530 may include a plurality of sensors 530 (stereo cameras) respectively corresponding to left and right eyes of a user. According to an embodiment, the sensor 530 may include a time of flight (TOF) sensor and/or a distance measuring camera (depth camera) using a depth sensor.

In the above, it has been described that information regarding gaze or viewpoints of the user is collected using an image sensor, but gaze or viewpoints of the user may be collected using other various types of sensors. For example, gaze or viewpoints of the user may be collected by various conventional embodiments, such as a contact lens method or a sensor attachment method.

According to an embodiment, the processor 520 may receive a video signal and/or an audio signal from the content receiver 510. For example, the processor 520 may decode the video signal into image data. According to an embodiment, the processor 520 may generate dimming data from the image data. The processor 520 may output the image data and dimming data to the panel driver (not illustrated) and the dimming driver 540, respectively.

According to an embodiment, the processor 520 may receive an image from the camera. According to an embodiment, the processor 520 may identify the presence of the user based on the image received from the sensor 530. The presence of the user may be detected, e.g., by facial recognition. For example, even when the user is present in the captured image, when the face of the user is not recognized (e.g., when the user is not viewing the display screen), the display device 100 may determine that the user is absent. According to an embodiment, the processor 520 may analyze the received image to obtain information regarding gaze or viewpoints of the user.

According to an embodiment, the processor 520 may track gaze of the user based on the information collected by the sensor 530. According to an embodiment, the processor 520 may track the gaze of the user based on the user image received from the sensor 530. According to an embodiment, the processor 520 may generate viewpoint data regarding viewpoints of the user, including, e.g., the position of the eyes of the user and the coordinates on the display 150 towards which the gaze of the user is directed. According to an embodiment, the processor 520 may calculate coordinate values of the eyes of the user corresponding to a planar orthogonal coordinate system of an X-axis and Y-axis (transverse and length directions of the display) based on the user image. According to an embodiment, the processor 520 may calculate coordinate values of the eyes of the user on the Z-axis, which is the direction heading the user, based on the user image. For example, coordinate values of the eyes of the user corresponding to a space orthogonal coordinate system of the X-axis, Y-axis, and Z-axis may be obtained by utilizing disclosed eye-tracking technologies. According to an embodiment, the processor 520 may track the gaze of the user by the sensor 530 to obtain the movement path of the actual viewpoint coordinates corresponding to the movement of the tracked gaze on the entire display screen of the display 150.

According to an embodiment, the processor 520 may determine a predicted viewpoint coordinate to which the gaze of the user is predicted to move on the entire display screen of the display 150 based on the movement path of the actual viewpoint coordinates.

According to an embodiment, the processor 520 may independently or individually control the first luminance value for the first display area including the predicted viewpoint coordinate and the second luminance value for the second display area excluding the first display area from the entire display screen of the display 150.

According to an embodiment, the processor 520 may control the second luminance value by applying to the second display area a gradually decreasing rate according to the separation distance from the predicted viewpoint coordinate.

According to an embodiment, the processor 520 may control the second luminance value so that the luminance of the second display area gradually decreases over a specific time period.

According to an embodiment, the processor 520 may control the first luminance value so that the luminance of the first display area immediately increases.

According to an embodiment, the processor 520 may identify one or more specific dimming blocks including the predicted viewpoint coordinate among a plurality of dimming blocks dividing the entire display screen of the display 150. The processor 520 may independently or individually control the luminance values of the identified one or more specific dimming blocks and the surrounding dimming blocks of the identified one or more specific dimming blocks.

According to an embodiment, the processor 520 may reduce the luminance value of a second surrounding dimming block, which is relatively farther from the predicted viewpoint coordinate among the surrounding dimming blocks, by a larger amount than the luminance value of a first surrounding dimming block, which is relatively closer to the predicted viewpoint coordinate.

According to an embodiment, if a specific actual viewpoint coordinate corresponding to the tracked gaze does not match the predicted viewpoint coordinate, the processor 520 may independently or individually control a third luminance value for a third display area including the specific actual viewpoint coordinates on the entire display screen of the display 150, and a fourth luminance value for a fourth display area excluding the third display area from the entire display screen of the display 150.

According to an embodiment, if the user whose gaze is to be tracked is not detected by the sensor 530 during a specific time period, the processor 520 may control the luminance value of the entire display screen of the display 150 so that the entire display screen has a luminance equal to or less than a threshold level.

According to an embodiment, if a plurality of users are detected by the sensor 530, the processor 520 may control the luminance value of the entire display screen of the display 150 so that the entire display screen has a reference brightness.

According to an embodiment, the processor 520 may obtain the separation distance from the display 150 to the user by the sensor 530 and control the second luminance value considering the separation distance.

According to an embodiment, the processor 520 may control the local dimming of the display 150. According to an embodiment, the processor 520 may supply different driving currents to light sources (e.g., the light source 311 of FIG. 3) belonging to different dimming blocks (e.g., the dimming block 301 of FIG. 3) according to dimming data. In this case, the light sources 311 belonging to different dimming blocks 301 may emit light of different brightness levels. Such operation of controlling the plurality of light sources 311 is referred to as “local dimming.”

According to an embodiment, the processor 520 may generate dimming data based on data received from the content receiver 510 and/or images received from the sensor 530. The dimming data may include information regarding the intensity of light emitted by each of the plurality of light sources (or dimming blocks) included in the light source device 550. The dimming data may be provided to the light source device 550 via the dimming driver 540.

According to an embodiment, the processor 520 may determine the luminance for each dimming block for each frame based on data received from the content receiver 510. According to an embodiment, the processor 520 may obtain a luminance adjustment ratio for each dimming block based on viewpoint data obtained by the sensor 530. According to an embodiment, the processor 520 may apply the luminance adjustment ratio obtained for each dimming block based on viewpoint data to the luminance determined for each dimming block based on data received from the content receiver 510 to determine the final output luminance. For example, the luminance adjustment ratio may be defined by the ratio of the luminance of the output image to the luminance of the input image. The luminance adjustment ratio may be a gain value that may be applied to the luminance of the input image to adjust the luminance of the output image. According to an embodiment, the processor 520 may generate dimming data based on the determined luminance.

For local dimming, the plurality of light sources 311 included in the light source device 550 may be divided into a plurality of dimming blocks 301 as illustrated in FIG. 3. In FIG. 3, a total of 60 dimming blocks in 5 rows and 12 columns are illustrated, but the number and arrangement of the dimming blocks are not limited to those illustrated in FIG. 3.

For example, each of the plurality of dimming blocks 301 may include at least one light source 311. The light source device 550 may supply the same driving current to the light sources 311 belonging to the same dimming block 301, and the light sources 311 belonging to the same dimming block 301 may emit light of the same brightness. For example, the light sources 311 belonging to the same dimming block 301 may be connected in series, thereby the same driving current may be supplied to the light sources 311 belonging to the same dimming block 301.

According to an embodiment, the dimming driver 540 may convert the dimming data, which is a digital voltage signal, into an analog signal (e.g., analog driving current or voltage). The dimming driver may sequentially provide analog dimming signals to each driving element that controls the driving current applied to each dimming block 301 in, e.g., an active matrix manner. Each driving element of the dimming blocks 301 may provide an analog driving current corresponding to the analog dimming signal to the light source device 550. By the analog driving current, the light sources 311 included in the light source device 550 may emit light.

According to an embodiment, the light source device 550 may include a plurality of driving elements (not illustrated) that control the driving current supplied to the light sources 311 included in each of the plurality of dimming blocks 301. The driving elements may be provided corresponding to at least one of the dimming blocks 301, respectively. Each of the driving elements may drive the dimming blocks 301.

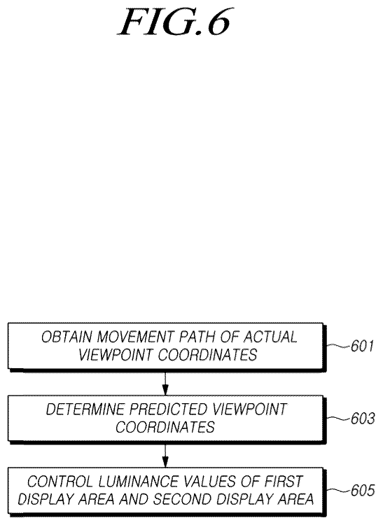

FIG. 6 is a flowchart illustrating a procedure for controlling local dimming in a display device 100 according to an embodiment.

In the following examples, each operation may be sequentially performed, but is not necessarily performed sequentially. For example, the order of each operation may be changed, and at least two operations may be performed in parallel.

Referring to FIG. 6, the display device 100 may, in operation 601, track gaze of a user to obtain a movement path on the entire display screen of the display (e.g., the display 150 of FIG. 1). In the following disclosure, the “entire display screen of the display 150” is abbreviated as “the entire display screen.” According to an embodiment, the display device 100 may track gaze of the user by at least one sensor (e.g., the sensor 530 of FIG. 5). The display device 100 may detect actual viewpoint coordinates corresponding to the movement of the tracked gaze on the entire display screen. The display device 100 may obtain the movement path of gaze of the user on the entire display screen based on the detected actual viewpoint coordinates. For example, the display device 100 may determine the movement path by connecting the detected actual viewpoint coordinates, which are periodically detected by tracking the gaze of the user. The actual viewpoint coordinates may be, e.g., coordinates on a planar orthogonal coordinates system toward which the gaze of the user is directed on the entire display screen. According to an embodiment, when the entire display screen includes a plurality of dimming blocks 301, the display device 100 may identify whether the actual viewpoint coordinates corresponding to the movement of the gaze of the user tracked by at least one sensor 130 have moved through a specific number or more of the dimming blocks 301 among the plurality of dimming blocks 301. For example, if the actual viewpoint coordinates have moved through a specific number or more of the dimming blocks 301, the display device 100 may obtain the movement path from a first actual viewpoint coordinate to a second actual viewpoint coordinate. The first actual viewpoint coordinate may be, e.g., an actual viewpoint coordinate first detected by tracking the gaze of the user. The first actual viewpoint coordinate may be, e.g., an actual viewpoint coordinate first detected after luminance control by local dimming based on the gaze of the user is performed. The second actual viewpoint coordinate may be, e.g., an actual viewpoint coordinate last detected by tracking the gaze of the user. The second actual viewpoint coordinates may be, e.g., an actual viewpoint coordinate detected at a time when luminance control by local dimming based on the gaze of the user is required. In this case, the movement path from the first actual viewpoint coordinate to the second actual viewpoint coordinate may be a path passing through a specific number or more of the dimming blocks 301.

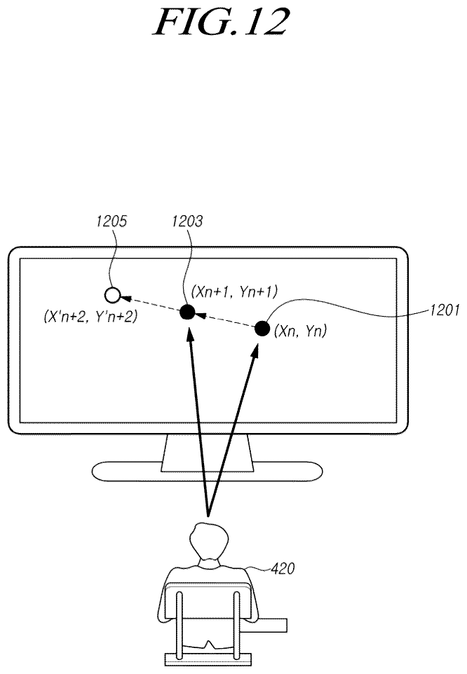

The display device 100 may, in operation 603, determine a predicted viewpoint coordinate on the entire display screen where the gaze of the user is predicted to move based on the movement path obtained based on the actual viewpoint coordinates. A detailed description thereof is provided below with reference to FIG. 12.

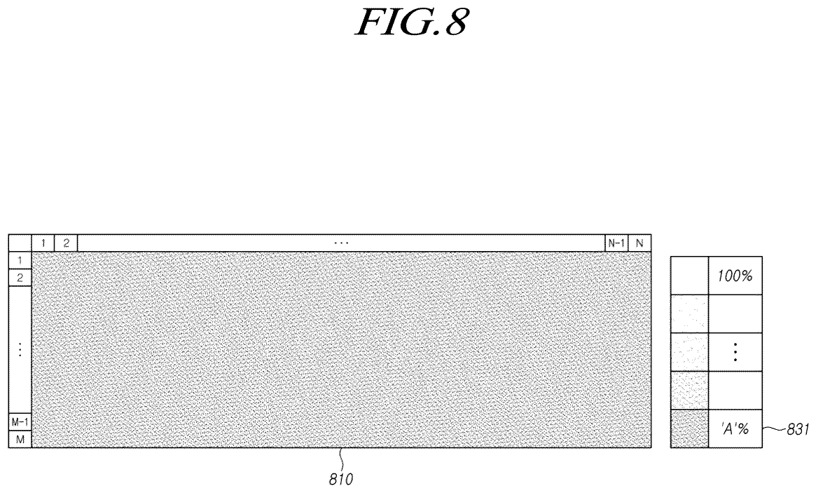

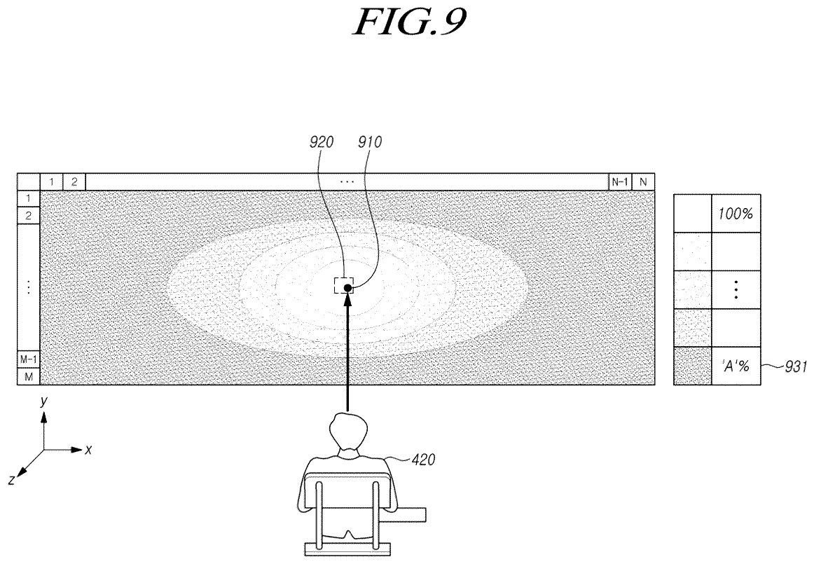

The display device 100 may, in operation 605, independently or individually control a first luminance value and a second luminance value. The first luminance value may be, e.g., a luminance value to be applied to a first display area including the predicted viewpoint coordinate on the entire display screen. The second luminance value may be, e.g., a luminance value to be applied to a second display area, which is the remaining display area excluding the first display area from the entire display screen. According to an embodiment, the display device 100 may control the first luminance value and the second luminance value differently. According to an embodiment, the display device 100 may control the first luminance value and the second luminance value identically. A detailed description thereof is provided below with reference to FIGS. 8 and 9.

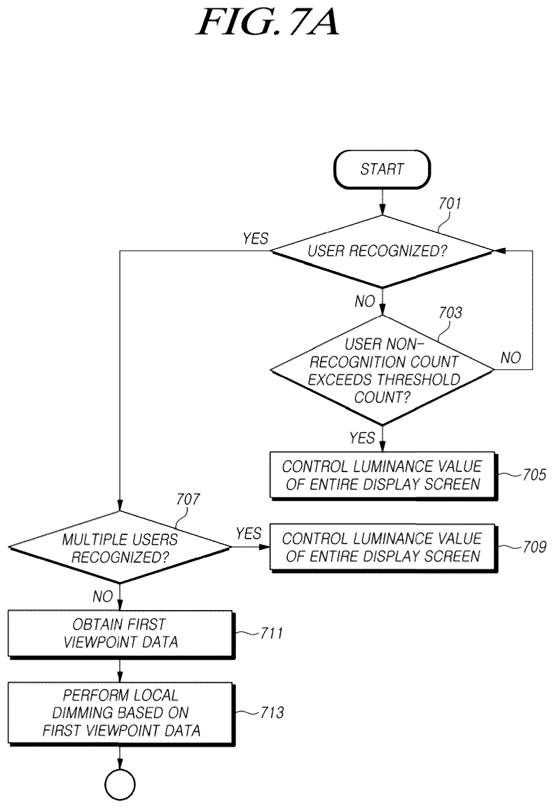

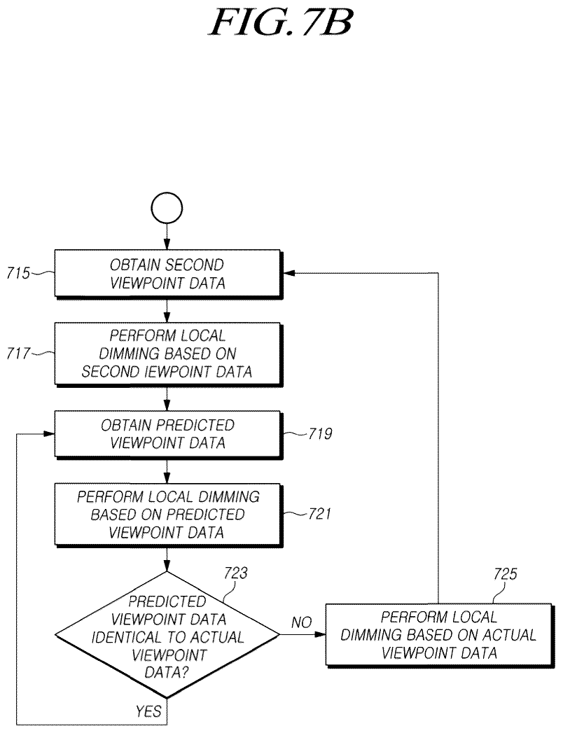

FIGS. 7A and 7B are a flowchart illustrating a procedure of controlling local dimming in a display device (e.g., the display device 100 of FIG. 1) according to an embodiment.

In the following examples, each operation may be sequentially performed, but is not necessarily performed sequentially. For example, the order of each operation may be changed, and at least two operations may be performed in parallel.

Referring to FIGS. 7A and 7B, the display device 100 may, in operation 701, identify the presence of the user. According to an embodiment, the display device 100 may identify the presence of the user based on images periodically or aperiodically captured by a camera (e.g., the sensor 530 of FIG. 5). The display device 100 may recognize the presence of the user, e.g., through facial recognition.

In response to identifying that the user is not present, e.g., not recognizing the user, the display device 100 may, in operation 703, determine whether the number of times in which the user is not recognized exceeds a threshold number. According to an embodiment, the display device 100 may count the number of images in which the user is not recognized (hereinafter referred to as the ‘number of times in which the user is not recognized’) among the images captured by the camera. For example, the threshold number may determine the frequency of adjusting luminance based on the gaze of the user. For example, by increasing the threshold number, the display device 100 may reduce the frequency of adjusting luminance based on the gaze of the user. For example, by decreasing the threshold number, the display device 100 may increase the frequency of adjusting luminance based on the gaze of the user. According to an embodiment, the display device 100 may set or update the threshold number based on a user input.

In response to the number of times in which the user is not recognized exceeding the threshold number, the display device 100 may, in operation 705, control the luminance value of the entire display screen. In the following disclosure, the ‘entire display screen of the display’ is abbreviated as ‘the entire display screen’. According to an embodiment, the display device 100 may uniformly reduce the luminance of the entire display screen. For example, the display device 100 may reduce the luminance of the entire display screen to a minimum value. According to an embodiment, the display device 100 may reduce the luminance of the entire display screen at the same rate. For example, the display device 100 may adjust the luminance adjustment ratio of each dimming block to a predetermined value (the luminance adjustment ratio is as described with reference to FIG. 5). For example, the predetermined value may be the same as the ‘minimum setting luminance adjust ratio’ implemented per block during local dimming. A detailed description of the minimum setting luminance adjust ratio is provided below with reference to FIG. 8.

The display device 100 may, in operation 707, recognize a plurality of users. For example, the display device 100 may recognize two, three, or more users. According to an embodiment, the display device 100 may initialize the number of times in which the user is not recognized to zero (0) before performing operation 707.

In response to recognizing a plurality of users, the display device 100 may, in operation 709, control the luminance value of the entire display screen. For example, the display device 100 may control the luminance value of the entire display screen so that the entire display screen has a reference brightness. The reference brightness is, e.g., the inherent brightness of content (e.g., an image input to the display device) that is not controlled based on the gaze of the user. For example, the display device 100 may adjust the luminance adjustment ratio of each dimming block to 100%. Here, the criterion for the plurality of users may be such a number of people that makes it difficult to specify a user whose movement of the viewpoint coordinates is to be tracked for applying local dimming.

If a plurality of users are not recognized, the display device 100 may, in operation 711, obtain viewpoint data regarding viewpoints of the user based on an image captured by a camera. In the following description, for convenience, numbers are allocated to the viewpoint data based on the order of the obtained viewpoint data. For example, the display device 100 may obtain the nth viewpoint data (where n is a natural number). For example, the display device 100 may sequentially obtain first viewpoint data, second viewpoint data, and third viewpoint data. The first viewpoint data, second viewpoint data, and third viewpoint data may be obtained from consecutive images or non-consecutive images among images captured by a sensor (e.g., the sensor 530 of FIG. 5). For example, the first viewpoint data may include coordinates (X1, Y1) indicating a point on the display toward which the gaze of the user is directed. For example, the first viewpoint data may include a coordinate (X1, Y1) indicating a point on the display toward which the gaze of the user is directed and a coordinate value Z1 corresponding to the position of the eyes of the user on the Z-axis, which is perpendicular to the display. For example, the coordinate value Z1 corresponds to the separation distance value between the display and the user (or the eyes of the user). According to an embodiment, the display device 100 may obtain viewpoint data periodically or aperiodically for a predetermined time period.

The display device 100 may, in operation 713, perform local dimming based on the obtained first viewpoint data. To this end, the display device 100 may obtain a first display area including the coordinate (X1, Y1). According to an embodiment, the display device 100 may control a first luminance value for the first display area so that the first display area has a reference brightness. For example, the display device 100 may set the luminance adjustment ratio to 100% to adjust the luminance of the first display area. According to an embodiment, the display device 100 may independently control a first luminance value for the first display area and a second luminance value for a second display area excluding the first display area from the entire display screen. According to an embodiment, the display device 100 may control the second luminance value by applying to the second display area a gradually decreasing rate according to the separation distance from the predicted viewpoint coordinate. According to an embodiment, the display device 100 may determine a luminance adjustment ratio for controlling the second luminance value. A detailed description of the luminance adjustment ratio for controlling the second luminance value is provided with reference to FIG. 9.

The display device 100 may, in operation 715, obtain a second viewpoint data. For example, the second viewpoint data may include a coordinate (X2, Y2) indicating a point on the display toward which the gaze of the user is directed. For example, the second viewpoint data may include a coordinate (X2, Y2) indicating a point on the display toward which the gaze of the user is directed and a coordinate value Z2 corresponding to the position of the eyes of the user on the Z-axis, which is perpendicular to the display. The second sensing data, which is used to provide the second viewpoint data, is obtained after the first sensing data, which is used to provide the first viewpoint data. The acquisition timings of the first sensing data and the second sensing data are not necessarily required to be consecutive.

The display device 100 may, in operation 717, perform local dimming based on the second viewpoint data. The local dimming in operation 717 is substantially the identical to or overlaps with the local dimming in operation 713, and thus, a description thereof is omitted.

The display device 100 may, in operation 719, obtain predicted viewpoint data based on the obtained first and second viewpoint data (viewpoint data (X1, Y1) and Z1, and (X2, Y2) and Z2). For example, the predicted viewpoint data may include a coordinate (X3′, Y3′) indicating a point on the display toward which the gaze of the user is predicted to be directed. For example, the predicted viewpoint data may include a coordinate (X3′, Y3′) indicating a point on the display toward which the gaze of the user is predicted to be directed and a coordinate value Z3′ corresponding to the predicted position of the eyes of the user on the Z-axis. The procedure for obtaining predicted viewpoint data is described in detail with reference to FIG. 12.

The display device 100 may, in operation 721, perform local dimming based on the predicted viewpoint data. The local dimming in operation 721 is substantially identical to or overlaps with the local dimming in operation 713, and thus, a description thereof is omitted.

The display device 100 may, in operation 723, identify whether the predicted viewpoint data and actual viewpoint data are substantially the same. For example, the actual viewpoint data may include a coordinate (X3, Y3) indicating a point on the display toward which the gaze of the user is directed. For example, the actual viewpoint data may include a coordinate (X3, Y3) and a coordinate value Z3 corresponding to the position of the eyes of the user on the Z-axis, which is perpendicular to the display. For example, the display device 100 may identify whether the coordinates (X3′, Y3′) are substantially the same as the coordinates (X3, Y3). For example, the display device 100 may identify whether the coordinate value Z3′ is substantially the same as the coordinate value Z3.

In response to a mismatch between the actual viewpoint data and the predicted viewpoint data, the display device 100 may, in operation 725, perform local dimming based on the actual viewpoint data. The display device 100 may return to operation 715 to obtain the actual viewpoint data. Subsequently, the display device 100 may perform the above-described local dimming operation 717 and operation 719 to obtain predicted viewpoint data.

Meanwhile, in response to the actual viewpoint data matching the predicted viewpoint data, the display device 100 may return to operation 719 to obtain predicted viewpoint data.

According to an embodiment, while performing any operation in FIG. 7, in response to not recognizing the user, the display device 100 may return to operation 703. For example, even when the display device 100 is performing operation 717, in response to identifying that the number of times in which the user is not recognized exceeds a threshold level, the display device 100 may control the luminance value of the entire display screen of the display 150 to have a brightness equal to or less than a threshold level.

FIG. 8 illustrates an operation of controlling the luminance of a display 150 when a user is not detected in a display device 100 according to an embodiment.

Referring to FIG. 8, if a target user whose gaze is to be tracked is not detected by at least one sensor (e.g., the sensor 530 of FIG. 5) for a predetermined time period, the display device 100 may control the luminance value of the entire display screen of the display 150 so that the entire display screen of the display 150 has a brightness equal to or less than the threshold level.

For example, the display device 100 may identify the presence of the user based on data collected by at least one sensor 530. The presence of the user may be detected, e.g., by facial recognition. For example, when the user is not facing the display screen, the face of the user may be considered unrecognized. Hereinafter, the presence of the user being not recognized may be referred to as user non-recognition.

For example, the display device 100 may determine whether user non-recognition is maintained for a predetermined time period. For example, the display device 100 may determine whether the time during which user non-recognition is maintained exceeds a time interval of the predetermined time period. For example, the display device 100 may obtain an image by at least one sensor 530 at a frame rate. For example, the display device 100 may identify whether the user is present in each obtained image. For example, the display device 100 may count the number of images in which the user is absent, i.e., images where the user is unrecognized (‘user non-recognition count’). For example, the display device 100 may identify whether the user non-recognition count exceeds a threshold count.

If the user is recognized before the user non-recognition count exceeds the threshold count, the display device 100 may reset the user non-recognition count. In this case, the reset value may be ‘0 (zero)’.

According to an embodiment, when the user non-recognition count exceeds the threshold count, the display device 100 may control the luminance value of the entire display screen 810 to have a brightness equal to or less than the threshold level. For example, the display device 100 may adjust the luminance adjustment ratio of all the dimming blocks to a predetermined value. For example, the predetermined value may be the same as the minimum setting luminance adjust ratio 831 implemented per block during local dimming. A detailed description of the minimum setting luminance adjust ratio is provided below with reference to FIG. 9. As such, the display device 100 may control the luminance value of the entire display screen 810 so that the entire display screen 810 has a brightness equal to or less than the threshold level if the target user whose gaze is to be tracked is not detected during a predetermined time period.

According to an embodiment, the display device 100 may control the luminance value of the entire display screen so that the entire display screen has a brightness equal to or less than the threshold level in the same manner as described above, even when determining that the user is present during a predetermined time period but the coordinates toward which the gaze of the user is directed on the display are not obtained (e.g., when the user is present in front surface of the display device 100 but is gazing at an area other than the display screen).

FIG. 9 illustrates an operation of obtaining a setting luminance adjust ratio during local dimming based on gaze of a user.

Referring to FIG. 9, the display device 100 may obtain a coordinate (Xn, Yn) 910 (where n is a natural number) indicating a point on the display toward which the gaze of the user 420 is directed in response to recognition of the user 420. For example, the display device 100 may determine on which dimming block among the plurality of dimming blocks the coordinate (Xn, Yn) 910 is positioned. For example, a dimming block 920 including the coordinate (Xn, Yn) 910 may be referred to as a ‘first block’.

According to an embodiment, the display device 100 may obtain setting luminance adjustment ratio of each dimming block area. According to an embodiment, the display device 100 may control the luminance of each dimming block area by applying the setting luminance adjustment ratio of each dimming block area to the content-based luminance of each dimming block area. For example, the setting luminance adjustment ratio of the first block area is 100%. In this case, the display device 100 may output the screen based on the original luminance without adjusting the luminance according to the content (e.g., an image input to the display device). For example, the luminance of the first block area is output as the content-based luminance of the first block area. For example, when the setting luminance adjustment ratio of any block area is 70%, the display device 100 may reduce the luminance of the block area to 70% of the content-based luminance of the block area.

According to an embodiment, the setting luminance adjustment ratio of each dimming block area follows the formula below.

$$Setting luminance adjustment ratio of each dimming block area = 100 - ( Dx * Δ x ) - ( Dy * Δ y )$$

Wherein,
Dx is the difference in luminance adjustment ratio per block unit in the x-axis direction;
Dy is the difference in luminance adjustment ratio per block unit in the y-axis direction;
Δx is the number of blocks from the first block to each block in the x-axis direction;
Δy is the number of blocks from the first block to each block in the y-axis direction.

According to an embodiment, Dx and Dy follow the formulas below.

$$Dx = ( 100 - A ) / ( N / 2 )$$

$$Dy = ( 100 - A ) / ( M / 2 )$$

Wherein, A is the minimum setting luminance adjustment ratio.

For example, when the setting luminance adjustment ratio of a predetermined block is calculated to be less than or equal to A according to the formula, the display device 100 may set the setting luminance adjustment ratio of the block to A.

In this case, the display device 100 may set the minimum setting luminance adjustment ratio 931 considering the separation distance Z between the display and the user. The area within a field of view of the user varies depending on the separation distance Z between the display and the user. For example, as the user moves away from the display device 100, the area within the field of view of the user may expand to encompass the entire display screen area. Conversely, as the user moves closer to the display device 100, the area within the field of view of the user may be reduced to a portion of the entire display screen area. For example, if the user is positioned close to the display device 100, the area within the field of view of the user may include at least a portion of the entire display screen.

According to an embodiment, the display device 100 may linearly increase the minimum setting luminance adjustment ratio as a viewing distance of the user becomes larger than a predetermined distance.

According to an embodiment, the display device 100 may identify that a viewing distance Z of the user falls within one of n areas (where n is a natural number equal to or greater than 1). In the following embodiments, it is described that the viewing distance Z of the user falls within one of three areas, but the disclosure is not limited thereto.

For example, when the Z value is less than a predetermined distance e, the display device 100 may set the minimum setting luminance adjustment ratio to A. For example, the predetermined distance may be an appropriate viewing distance for the display device 100 to provide a stereoscopic image, but the disclosure is not limited thereto.

For example, when the Z value is equal to or larger than the predetermined distance e and equal to or less than a distance f where the entire display screen area falls within the field of view of the user, the display device 100 may set the minimum setting luminance adjustment ratio to Az. For example, the distance f may be determined depending on the size of the display screen. For example, Az follows the formula below.

$$Az = A + ( 100 - A ) * ( Z - e ) / ( f - e )$$

For example, when the Z value is larger than the distance f, the display device 100 may set the minimum setting luminance adjustment ratio to 100%.

As such, the display device 100 may independently control a first luminance value for a first display area including a coordinate indicating a point toward which gaze of the user is directed and a second luminance value for a second display area excluding the first display area from the entire display screen. For example, the display device 100 may control the second luminance value by applying to the second display area a gradually decreasing rate according to the separation distance from the predicted viewpoint coordinate. In this case, the display device 100 may obtain the separation distance between the display and the user and determine the minimum setting luminance adjust ratio for controlling the second luminance value considering the obtained separation distance. According to an embodiment, the display device 100 may control the second luminance value considering the separation distance between the display and the user.

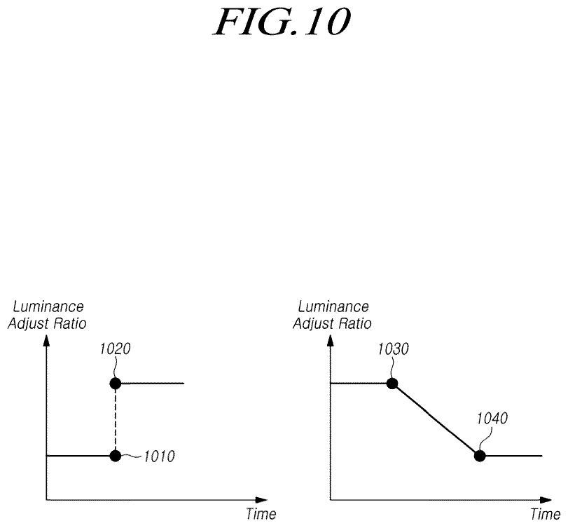

FIG. 10 illustrates an operation of changing a luminance adjust ratio in a display device 100 according to an embodiment. According to an embodiment, the display device 100 may increase the luminance adjust ratio. According to an embodiment, the display device 100 may decrease the luminance adjust ratio.

The left and right diagrams of FIG. 10 illustrate the time-dependent luminance adjust ratio of any dimming block.

As described with reference to FIG. 9, the display device 100 may obtain a setting luminance adjust ratio of any dimming block for local dimming based on the gaze of the user. According to an embodiment, the display device 100 may obtain a luminance adjust ratio applied to any dimming block at a specific time. According to an embodiment, the display device 100 may obtain a luminance adjust ratio applied before applying the setting luminance adjust ratio. Hereinafter, the luminance adjust ratio applied before applying the setting luminance adjust ratio may be referred to as a start luminance adjust ratio. When the display device 100 is first turned on or when the content image displayed on the display is changed, the start luminance adjust ratio may be 100%, but the disclosure is not limited thereto.

Referring to the left diagram illustrating FIG. 10, the display device 100 may maintain the start luminance adjust ratio 1010 as the setting luminance adjust ratio 1020 or immediately increase the start luminance adjust ratio 1010 when the setting luminance adjust ratio 1020 is equal to or higher than the start luminance adjust ratio 1010. Accordingly, the user may immediately see the screen displayed in the first display area brightly and clearly. p Referring to the right diagram illustrating FIG. 10, the display device 100 may decrease the start luminance adjust ratio 1030 to the setting luminance adjust ratio 1040 over a predetermined time period when the setting luminance adjust ratio 1040 of any dimming block is lower than the start luminance adjust ratio 1030. As such, the display device 100 may stepwise decrease the luminance of the second display area over a predetermined time period. Accordingly, the user may not perceive the decrease in luminance of the second display area.

According to an embodiment, the change of the luminance adjust ratio per time unit follows the calculation formula below.

$$Change of luminance adjust ratio per time unit = \vert ( setting luminance adjust ratio - start luminance adjust ratio ) \vert / falling time$$

Wherein,
the setting luminance adjust ratio may be obtained in the manner described with reference to FIG. 9;
the start luminance adjust ratio is a luminance adjust ratio applied before the display device 100 applies the setting luminance adjust ratio;
the falling time (FT) may be a time interval between 1 s and 20 s, but the disclosure is not limited thereto.

According to an embodiment, the display device 100 may obtain the start luminance adjust ratio in response to obtaining viewpoint data regarding the gaze of the user (e.g., coordinates (Xn, Yn) toward which the gaze of the user is directed on the display). According to an embodiment, the display device 100 may obtain the start luminance adjust ratio in response to obtaining the setting luminance adjust ratio.

Accordingly, the display device 100 may determine a luminance adjust ratio of each dimming block at a specific time point. According to an embodiment, the display device 100 may apply the luminance adjust ratio determined for the dimming block to the frame to be output on the screen. For example, the display device 100 may immediately increase the luminance adjust ratio for the dimming block of the first display area. For example, the display device 100 may gradually decrease the luminance adjust ratio for the dimming block included in the second display area. According to the embodiment, the display device 100 may control the first luminance value for the first display area so that the brightness of the first display area may immediately increase. According to the embodiment, the display device 100 may control the second luminance value for the second display area so that the brightness of the second display area may gradually decrease over the predetermined time period. Accordingly, the display device 100 may reduce power consumption without affecting the image quality perceived by the user.

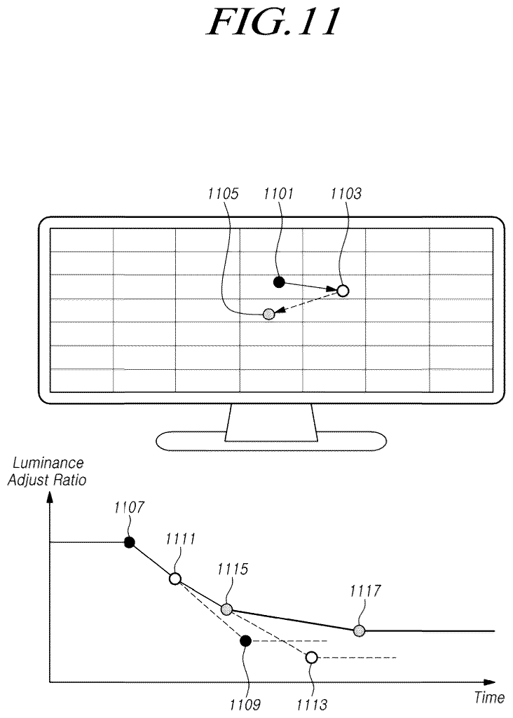

FIG. 11 is a view illustrating an operation of updating a luminance adjust ratio in response to gaze of a user in a display device 100 according to an embodiment.

Referring to the upper diagram illustrating FIG. 11, the display device 100 may analyze information regarding gaze of the user to predict or measure to obtain a reference coordinate toward which gaze of the user is directed on the entire display screen. For example, the display device 100 may obtain a reference coordinate (X1, Y1) 1101. The display device 100 may obtain a reference coordinate (X2, Y2) 1103. The display device 100 may obtain a reference coordinate (X3, Y3) 1105. For example, the reference coordinate (X1, Y1) 1101, reference coordinate (X2, Y2) 1103, and reference coordinate (X3, Y3) 1105 may be obtained successively in accordance with the progression of time. For convenience of description, the reference coordinate (X1, Y1) 1101, reference coordinate (X2, Y2) 1103, and reference coordinate (X3, Y3) 1105 are referred to as a first reference coordinate, a second reference coordinate, and a third reference coordinate, respectively, but the reference coordinates are not limited to being obtained during a consecutive time period.

According to an embodiment, in response to identifying a change in the viewpoint data (e.g., including the reference coordinates and/or the separation distance between the display and the user), the display device 100 may perform local dimming based on the changed viewpoint data. According to an embodiment, each time local dimming based on the viewpoint data is performed, the display device 100 may newly obtain a setting luminance adjust ratio and a currently applied luminance adjust ratio for any dimming block. For example, before the falling time FT according to local dimming based on specific viewpoint data elapses, the display device 100 may identify a change in the viewpoint data. In this case, the display device 100 may perform local dimming based on the changed viewpoint data, even when the falling time FT according to local dimming based on specific viewpoint data has not elapsed. For example, the change in the viewpoint data includes a change (or movement) of a reference coordinate. For example, in response to identifying a change (or movement) of a reference coordinate, the display device 100 may perform local dimming based on the changed reference coordinate.

The graph at the bottom of FIG. 11 illustrates the luminance adjust ratio over time for any block included in the second display area when the reference coordinates move as illustrated at the top of FIG. 11.

For example, in response to obtaining the first reference coordinate 1101, the display device 100 may obtain a setting luminance adjust ratio 1109 to perform local dimming. The setting luminance adjust ratio 1109 may be referred to as a first setting luminance adjust ratio 1109. According to an embodiment, the display device 100 may obtain a start luminance adjust ratio 1107 applied before applying the first setting luminance adjust ratio 1109. The start luminance adjust ratio 1107 may be referred to as a first start luminance adjust ratio 1107. According to an embodiment, the display device 100 may decrease the luminance adjust ratio from the first start luminance adjust ratio 1107 to the first setting luminance adjust ratio 1109 during a first falling time FT1.

For example, in response to obtaining the second reference coordinate 1103 before the first falling time FT1 elapses, the display device 100 may obtain a setting luminance adjust ratio 1113 to perform local dimming. The setting luminance adjust ratio 1113 may be referred to as a second setting luminance adjust ratio 1113. According to an embodiment, the display device 100 may obtain a start luminance adjust ratio 1111 applied before applying the second setting luminance adjust ratio 1113. The start luminance adjust ratio 1111 may be referred to as a second start luminance adjust ratio 1111. According to an embodiment, the display device 100 may decrease the luminance adjust ratio from the second start luminance adjust ratio 1111 to the second setting luminance adjust ratio 1113 during a second falling time FT2.

For example, in response to obtaining the third reference coordinate 1105 before the second falling time FT2 elapses, the display device 100 may obtain a setting luminance adjust ratio 1117 to perform local dimming. The setting luminance adjust ratio 1117 may be referred to as a third setting luminance adjust ratio 1117. According to an embodiment, the display device 100 may obtain a start luminance adjust ratio 1115 applied before applying the third setting luminance adjust ratio 1117. The start luminance adjust ratio 1115 may be referred to as a third start luminance adjust ratio 1115. According to an embodiment, the display device 100 may decrease the luminance adjust ratio from the third start luminance adjust ratio 1115 to the third setting luminance adjust ratio 1117 during a third falling time FT3. According to an embodiment, the first falling time FT1, second falling time FT2, and third falling time FT3 may be equal to or different from each other.

According to an embodiment, in the display device 100, a falling time FT may be longer than the time required to determine a predicted viewpoint coordinate where gaze of the user is predicted to move on the entire display screen, based on the movement path of actual viewpoint coordinates. The movement path of the actual viewpoint coordinates corresponding to the movement of the tracked gaze on the entire display screen of the display 150 may be obtained by tracking gaze of the user. According to an embodiment, the display device 100 may obtain a predicted viewpoint coordinate before the predetermined falling time FT elapses and perform local dimming based on the predicted viewpoint coordinate.

FIG. 12 is a view illustrating the determination of a predicted viewpoint coordinate in a display device according to an embodiment.

Referring to FIG. 12, the display device 100 may track gaze of a user by at least one sensor 130 to obtain the movement path of actual viewpoint coordinates corresponding to the movement of the tracked gaze on the entire display screen, and determine a predicted viewpoint coordinate, where the gaze of the user is predicted to move, based on the movement path of the actual viewpoint coordinates.

For example, the display device 100 may track gaze of the user by at least one sensor (e.g., the sensor 530 of FIG. 5) to obtain the movement path of actual viewpoint coordinates (Xn, Yn) 1201 and (Xn+1, Yn+1) 1203 corresponding to the movement of the tracked gaze on the entire display screen of the display 150. According to an embodiment, the actual viewpoint coordinates (Xn, Yn) 1201 and (Xn+1, Yn+1) 1203 may be obtained from consecutive or non-consecutive images captured by a camera (e.g., the sensor 530 of FIG. 5). According to an embodiment, the display device 100 may obtain a predicted viewpoint coordinate (X′n+2, Y′n+2) 1205, where the gaze of the user is predicted to move, based on the movement path of the actual viewpoint coordinates (Xn, Yn) 1201 and (Xn+1, Yn+1) 1203.

For example, the predicted viewpoint coordinate (X′n+2, Y′n+2) 1205 may be determined according to the following equations I and II.

$${X}^{′} n + 2 = Xn + 1 + ( Xn + 1 - Xn ) \qquad equation I$$

$${Y}^{′} n + 2 = Yn + 1 + ( Yn + 1 - Yn ) \qquad equation II$$

According to an embodiment, the display device 100 may perform local dimming based on the predicted viewpoint coordinate (X′n+2, Y′n+2) 1205. According to an embodiment, the display device 100 may independently control a first luminance value for a first display area including the predicted viewpoint coordinate on the entire display screen and a second luminance value for a second display area excluding the first display area from the entire display screen.

According to an embodiment, the display device 100 may track the gaze of the user by at least one sensor 530 to obtain a change in the separation distances Zn and Zn+1 between the display and the user. According to an embodiment, the separation distances Zn and Zn+1 may be obtained from consecutive or non-consecutive images captured by a camera (e.g., the sensor 530 of FIG. 5). According to an embodiment, the display device 100 may obtain a predicted separation distance Z′n+2, where the user is predicted to move, based on the change in the separation distances Zn and Zn+1.

For example, the predicted separation distance Z′n+2 may be determined according to the following equation III.

$${Z}^{′} n + 2 = Zn + 1 + ( Zn + 1 - Zn ) \qquad equation III$$

According to an embodiment, the display device 100 may perform local dimming based on the predicted viewpoint coordinate (X′n+2, Y′n+2) 1205 and the predicted separation distance Z′n+2.

According to an embodiment, the display device 100 may track the gaze of the user by at least one sensor 530 to obtain a specific actual viewpoint coordinate (Xn+2, Yn+2). According to an embodiment, the display device 100 may compare whether the predicted viewpoint coordinate (X′n+2, Y′n+2) and the actual viewpoint coordinate (Xn+2, Yn+2) are substantially the same. According to an example, the time interval between the acquisition of sensing data for obtaining the actual viewpoint coordinate (Xn, Yn) 1201 and the acquisition of sensing data for obtaining the actual viewpoint coordinate (Xn+1, Yn+1) 1203 may be

substantially the same as the time interval between the acquisition of sensing data for obtaining the actual viewpoint coordinate (Xn+1, Yn+1) 1203 and the acquisition of sensing data for obtaining the actual viewpoint coordinate (Xn+2, Yn+2).

According to an embodiment, when the predicted viewpoint coordinate (X′n+2, Y′n+2) and the actual viewpoint coordinate (Xn+2, Yn+2) are substantially the same, the display device 100 may repeat the prediction operation. For example, after obtaining the actual viewpoint coordinate (Xn+2, Yn+2), the display device 100 may substitute Xn with Xn+1 and Xn+1 with Xn+2 in equation I, and substitute Yn with Yn+1 and Yn+1 with Yn+2 in equation II to obtain an additional predicted viewpoint coordinate.

According to an embodiment, when the predicted viewpoint coordinate and the actual viewpoint coordinate do not substantially match, the display device 100 may perform local dimming based on the actual viewpoint coordinate (Xn+2, Yn+2). After additionally obtaining an actual viewpoint coordinate on the display, where the gaze of the user is directed, from the image captured by the camera, the display device 100 may perform a prediction operation based on the obtained actual viewpoint coordinates. For example, when the predicted viewpoint coordinate and the actual viewpoint coordinate do not substantially match, the display device 100 may perform operation 725 and then return to operation 715, as illustrated in FIG. 7.

According to an embodiment, the display device 100 may predict viewpoint data of the user and perform local dimming based on the predicted viewpoint data. Accordingly, the local dimming may be smoothly performed without delay depending on the acquisition and processing of the actual viewpoint data by the processor 520.

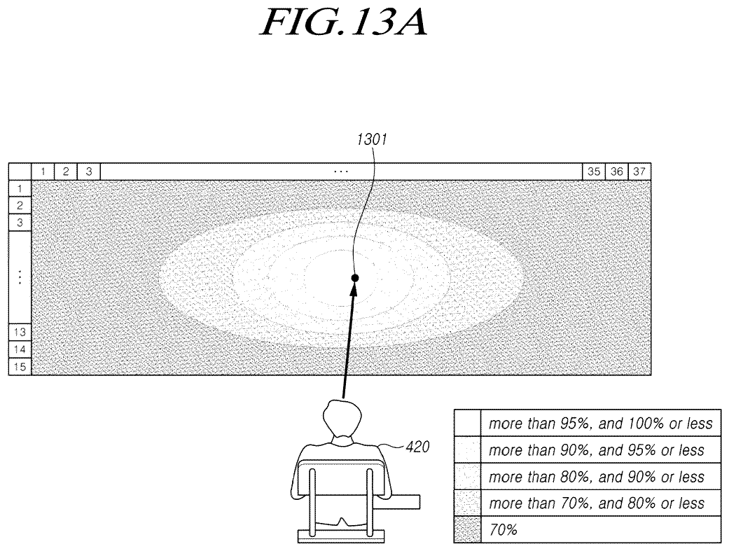

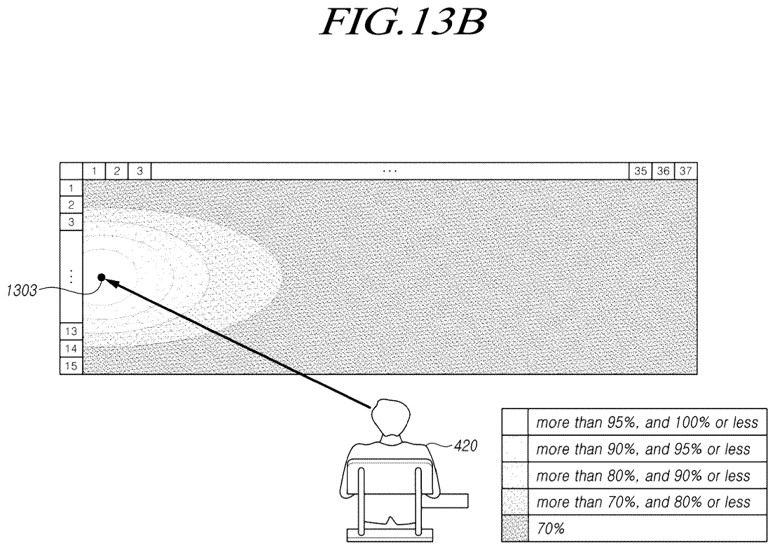

FIGS. 13A and 13B illustrate simulation results related to luminance control of a display according to an embodiment.

Referring to FIGS. 13A and 13B, the display device 100 may include 15×37 dimming blocks. The minimum setting luminance adjust ratio for local dimming was set to 70%.

Referring to FIG. 13A, when the coordinate 1301, where gaze of a user is directed on the display screen of the display 150, was positioned in the central area of the display screen of the display 150, the power consumption was identified to be decreased by 25.4%.

Referring to FIG. 13B, when the coordinate 1303, where gaze of the user is directed on the display screen of the display 150, was positioned in a peripheral area of the display screen of the display 150, the power consumption was identified to be decreased by 27.5%. As such, when the coordinate, where the gaze of the user is directed on the display screen of the display 150, is positioned in a peripheral area of the display screen of the display 150, the power consumption may be further decreased compared to when positioned in the central area of the display screen of the display 150.

According to an embodiment, a display device 100 may comprise at least one sensor 130, a display 150, memory 160 including one or more storage media storing instructions, and at least one processor 120 including a processing circuit. The instructions may, when executed individually and/or collectively by the at least one processor 120, cause the display device 100 to track gaze of a user by the at least one sensor 130 to obtain a movement path of actual viewpoint coordinates corresponding to a movement of the tracked gaze on an entire display screen of the display 150, determine a predicted viewpoint coordinate to which the gaze of the user is predicted to move on the entire display screen based on the movement path of the actual viewpoint coordinates, and independently control a first luminance value for a first display area including the predicted viewpoint coordinate and a second luminance value for a second display area excluding the first display area from the entire display screen.

According to an embodiment, the instructions may, when executed individually or collectively by the at least one processor 120, cause the display device 100 to control the second luminance value by applying to the second display area a gradually decreasing rate according to a separation distance from the predicted viewpoint coordinate.

According to an embodiment, the instructions may, when executed individually or collectively by the at least one processor 120, cause the display device 100 to perform control the second luminance value so that a brightness of the second display area gradually decreases over a specific time period.

According to an embodiment, the instructions may, when executed individually or collectively by the at least one processor 120, cause the display device 100 to control the first luminance value so that a brightness of the first display area immediately increases.

According to an embodiment, the instructions may, when executed individually or collectively by the at least one processor 120, cause the display device 100 to identify a specific dimming block including the predicted viewpoint coordinate among a plurality of dimming blocks dividing the entire display screen, and independently control luminance values of the identified specific dimming block and surrounding dimming blocks of the identified specific dimming block.

According to an embodiment, the instructions may, when executed individually or collectively by the at least one processor 120, cause the display device 100 to decrease a luminance value of a second surrounding dimming block, which has a relatively larger separation distance from the predicted viewpoint coordinate among the surrounding dimming blocks, by a larger amount than a luminance value of a first surrounding dimming block, which has a relatively shorter separation distance from the predicted viewpoint coordinate.

According to an embodiment, the instructions may, when executed individually or collectively by the at least one processor 120, cause the display device 100 to independently control a third luminance value for a third display area including the specific actual viewpoint coordinates and a fourth luminance value for a fourth display area excluding the third display area from the entire display screen when the specific actual viewpoint coordinates corresponding to the tracked gaze do not match the predicted viewpoint coordinate.

According to an embodiment, the instructions may, when executed individually or collectively by the at least one processor 120, cause the display device 100 to control a luminance value of the entire display screen to have a brightness equal to or less than a threshold level when a target user whose gaze is to be tracked is not detected for a specific time period by the at least one sensor 130.

According to an embodiment, the instructions may, when executed individually or collectively by the at least one processor 120, cause the display device 100 to control a luminance value of the entire display screen to have a reference brightness when a plurality of users are detected by the at least one sensor 130.

According to an embodiment, the instructions may, when executed individually or collectively by the at least one processor 120, cause the display device 100 to obtain a separation distance from the display 150 to the user by the at least one sensor 130, and control the second luminance value considering the separation distance from the display 150 to the user.

According to an embodiment, a method for controlling a display device 100 may comprise tracking gaze of a user by at least one sensor 130 to obtain a movement path of actual viewpoint coordinates corresponding to a movement of the tracked gaze on an entire display screen of a display 150, determining a predicted viewpoint coordinate to which the gaze of the user is predicted to move on the entire display screen based on the movement path of the actual viewpoint coordinates, and independently controlling a first luminance value for a first display area including the predicted viewpoint coordinate and a second luminance value for a second display area excluding the first display area from the entire display screen.

According to an example, the method may comprise controlling the second luminance value by applying to the second display area a gradually decreasing rate according to a separation distance from the predicted viewpoint coordinate.

According to an example, the method may comprise controlling the second luminance value so that a brightness of the second display area gradually decreases over a specific time period.

According to an example, the method may comprise controlling the first luminance value so that a brightness of the first display area immediately increases.

According to an example, the method may comprise identifying a specific dimming block including the predicted viewpoint coordinate among a plurality of dimming blocks dividing the entire display screen, and independently controlling luminance values of the identified specific dimming block and surrounding dimming blocks of the identified specific dimming block.

According to an example, the method may comprise decreasing a luminance value of a second surrounding dimming block, which has a relatively larger separation distance from the predicted viewpoint coordinate among the surrounding dimming blocks, by a larger amount than a luminance value of a first surrounding dimming block, which has a relatively shorter separation distance from the predicted viewpoint coordinate.

According to an example, the method may comprise independently controlling a third luminance value for a third display area including a specific actual viewpoint coordinate and a fourth luminance value for a fourth display area excluding the third display area from the entire display screen when the specific actual viewpoint coordinates corresponding to the tracked gaze do not match the predicted viewpoint coordinate.

According to an example, the method may comprise controlling a luminance value of the entire display screen to have a brightness equal to or less than a threshold level when a target user whose gaze is to be tracked is not detected for a predetermined time period by the at least one sensor 130.

According to an example, the method may comprise controlling a luminance value of the entire display screen to have a reference brightness when a plurality of users are detected by the at least one sensor 130.

According to an example, the method may comprise obtaining a separation distance from the display 150 to the user by the at least one sensor 130, and controlling the second luminance value considering the separation distance from the display 150 to the user.

Various embodiments herein are provided merely for better understanding of the disclosure, and the disclosure should not be limited thereto or thereby. It should be appreciated by one of ordinary skill in the art that various changes in form or detail may be made to the embodiments without departing from the scope of the disclosure defined by the following claims.

1. A display device, comprising:
a sensor;
a display screen;
memory configured to store instructions; and
at least one processor configured to, individually and/or collectively, execute the stored instructions to:
based on information obtained by the sensor, track a gaze of a user to obtain a movement path of viewpoint coordinates corresponding to a movement path of the tracked gaze on the display screen,
determine a predicted viewpoint coordinate to which the gaze of the user is predicted to move on the display screen based on the obtained movement path of the viewpoint coordinates,
control a first luminance value for a first display area of the display screen that includes the predicted viewpoint coordinate, and
control a second luminance value for a second display area of the display screen, the second luminance value being different from the first luminance value, and the second display area excluding the first display area.

2. The display device of claim 1, wherein the instructions are configured to control the second luminance value to decrease based on a separation distance from the predicted viewpoint coordinate.

3. The display device of claim 1, wherein the instructions are configured to control the second luminance value such that a brightness of the second display area decreases over a time period.

4. The display device of claim 1, wherein the instructions are configured to control the first luminance value such that a brightness of the first display area immediately increases.

5. The display device of claim 1, wherein
the instructions are configured to:
identify a dimming block of the display screen that includes the predicted viewpoint coordinate among a plurality of dimming blocks that divide the display screen, and
independently control a luminance value of the identified dimming block and luminance values of dimming blocks among the plurality of dimming blocks that surround the identified dimming block.

6. The display device of claim 5, wherein
a first dimming block among the dimming blocks that surround the identified dimming block has a first separation distance from the predicted viewpoint coordinate,
a second dimming block among the dimming blocks that surround the identified dimming block has a second separation distance from the predicted viewpoint coordinate that is larger than the first separation distance, and
the instructions are further configured to decrease a luminance value of the second dimming block by a larger amount than a luminance value of the first dimming block.

7. The display device of claim 1, wherein
the instructions are configured to:
based on a viewpoint coordinate corresponding to the gaze of the user not matching the predicted viewpoint coordinate,
control a third luminance value for a third display area of the display screen that includes the viewpoint coordinate corresponding to the gaze of the user, and
control a fourth luminance value for a fourth display area of the display screen, the fourth display area excluding the third display area.

8. The display device of claim 1, wherein
the instructions are configured to:
based on the determination that the gaze of the user is not detected for a time period, control a luminance value for an entirety of the display screen to have a brightness equal to or less than a threshold level.

9. The display device of claim 1, wherein
the instructions are configured to:
based on the determination that a plurality of users are gazing at the display screen, control a luminance value for an entirety of the display screen to have a reference brightness.

10. The display device of claim 1, wherein
the instructions are configured to:
based on the information obtained by the sensor, obtain a separation distance between the display screen and the user, and
control the second luminance value based on the obtained separation distance between the display screen and the user.

11. A method for controlling a display device including a sensor, a display screen, memory configured to store instructions, and at least one processor configured to, individually and/or collectively, execute the stored instructions to perform the method, the method comprising:
based on information obtained by the sensor, tracking a gaze of a user to obtain a movement path of viewpoint coordinates corresponding to a movement path of the tracked gaze on the display screen;
determining a predicted viewpoint coordinate to which the gaze of the user is predicted to move on the display screen based on the obtained movement path of the viewpoint coordinates;
controlling a first luminance value for a first display area of the display screen that includes the predicted viewpoint coordinate; and
controlling a second luminance value for a second display area of the display screen, the second luminance value being different from the first luminance value, and the second display area excluding the first display area.

12. The method of claim 11, further comprising controlling the second luminance value to decrease based on a separation distance from the predicted viewpoint coordinate.

13. The method of claim 11, further comprising controlling the second luminance value such that a brightness of the second display area decreases over a time period.

14. The method of claim 11, further comprising controlling the first luminance value such that a brightness of the first display area immediately increases.

15. The method of claim 11, further comprising:
identifying a dimming block of the display screen that includes the predicted viewpoint coordinate among a plurality of dimming blocks that divide the display screen, and
independently controlling a luminance value of the identified dimming block and luminance values of dimming blocks among the plurality of dimming blocks that surround the identified dimming block.

16. The method of claim 15, wherein
a first dimming block among the dimming blocks that surround the identified dimming block has a first separation distance from the predicted viewpoint coordinate,
a second dimming block among the dimming blocks that surround the identified dimming block has a second separation distance from the predicted viewpoint coordinate that is larger than the first separation distance, and
the method further includes decreasing a luminance value of the second dimming block by a larger amount than a luminance value of the first dimming block.

17. The method of claim 11, further comprising:
based on a viewpoint coordinate corresponding to the gaze of the user according to the information obtained by the sensor not matching the predicted viewpoint coordinate,
controlling a third luminance value for a third display area of the display screen that includes the viewpoint coordinate corresponding to the gaze of the user, and
controlling a fourth luminance value for a fourth display area of the display screen, the fourth display area excluding the third display area.

18. The method of claim 11, further comprising:
based on the determination that the gaze of the user is not detected for a time period, controlling a luminance value for an entirety of the display screen to have a brightness equal to or less than a threshold level.

19. The method of claim 11, further comprising:
based on the determination that a plurality of users are gazing at the display screen, controlling a luminance value for an entirety of the display screen to have a reference brightness.

20. The method of claim 11, further comprising:
based on the information obtained by the sensor, obtaining a separation distance between the display screen and the user; and
controlling the second luminance value based on the obtained separation distance between the display screen and the user.
